(19) United States
(12) Patent Application Publication
(10) Pub. No.: US 2026/0203908 A1
(43) Pub. Date: Jul. 16, 2026

(54) SUBDOMAIN-BASED TRAINING TECHNIQUES FOR PREDICTIVE MODELS OF FLUID SYSTEMS

(71) Applicant: SCHLUMBERGER TECHNOLOGY CORPORATION, Sugar Land, TX (US)

(72) Inventor: Soham Sheth, Abingdon (GB)

(21) Appl. No.: 19/134,713

(22) PCT Filed: Dec. 1, 2023
(86) PCT No.: PCT/US2023/082141

§ 371 Date: May 31, 2025

Related U.S. Application Data
(60) Provisional application No. 63/385,691, filed on Dec. 1, 2022.
(60) Provisional application No. 63/385,869, filed on Dec. 2, 2022.

(51) Int. Cl. G06T 7/11; E21B 34/06; E21B 41/00; E21B 49/08; G01V 20/00; G06T 3/4007; G06T 7/60

(52) U.S. Cl. CPC G06T 7/11; E21B 34/06; E21B 41/0064; E21B 49/08; G01V 20/00; G06T 3/4007; G06T 7/60; E21B 2200/20; E21B 2200/22; G06T 2207/20021; G06T 2207/20081; G06T 2207/20084; G06T 2207/30181

(57) ABSTRACT

A method includes receiving image data corresponding to a plurality of measured fluid properties of a subterranean region. The method also includes generating a plurality of sub-images within the image data, wherein each sub-image corresponds to a different location of the subterranean region. Further, the method includes generating a model by training the model using the plurality of sub-images, wherein training the model comprises transforming each sub-image into a reduced space and generating a predicted image data based on the sub-image transformed into the reduced space.

### CROSS-REFERENCE TO RELATED APPLICATIONS

This application claims priority to U.S. Provisional Patent Application No. 63/385,869, filed on Dec. 2, 2022, and U.S. Provisional Patent Application No. 63/385,691, filed on Dec. 1, 2022, which are incorporated herein by reference in their entirety.

### FIELD

This disclosure relates generally to generating a model used for oil and gas operations using a sub-image training technique.

### BACKGROUND

Oil and gas operations are improved by data from a variety of sources. For example, an operator may select suitable locations to drill based on reservoir data. In general, the reservoir data may indicate a presence and/or amount of certain fluids within a subterranean region. However, the presence and/or amount of the fluids changes over time due to external factors, such as drilling in a nearby well, absorption of the fluids into porous media, and the like. As such, it can be difficult to accurately use reservoir data to inform oil and gas decisions. Accordingly, it may be advantageous to develop a model for reservoir simulations that provides insights into how fluid properties of the reservoir may change over time. Reservoir simulations are a numerical method of modeling fluid flow processes in porous media and useful in field development planning workflows.

For example, it may be desirable to train a model for reservoir simulations such that an enterprise may utilize insights gained from the reservoir simulations to efficiently recover resources from a subterranean formation and make decisions related to a field development planning workflow. However, training such a model is difficult due to the non-linearity of the conservation equations. Certain models, such as auto-encoder architectures, may be useful for modeling of subterranean properties, such as fluid properties. However, training such models may consume a relatively large amount of time and resources. For example, a simulator which is inherently slow may need to be run thousands of times in order to facilitate a robust decision making process.

As such, a solution is needed to provide assistance for effective and efficient oil and gas operations.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Various refinements of the features noted above may be made in relation to various aspects of this disclosure. Further features may also be incorporated in these various aspects as well. These refinements and additional features may be made individually or in any combination. For instance, various features discussed below in relation to one or more of the illustrated embodiments may be incorporated into any of the above-described aspects of this disclosure alone or in any combination. The brief summary presented above is intended only to familiarize the reader with certain aspects and contexts of embodiments of this disclosure without limitation to the claimed subject matter.

One aspect of the present disclosure is directed to a method. The method includes receiving image data corresponding to a plurality of measured fluid properties of a subterranean region. The method also includes generating a plurality of sub-images within the image data, wherein each sub-image corresponds to a different location of the subterranean region. Further, the method includes generating a model by training the model using the plurality of sub-images, wherein training the model comprises transforming each sub-image into a reduced space and generating a predicted image data based on the sub-image transformed into the reduced space. Further still, the method includes adjusting operation of a fluid system based on the generated model.

Another aspect of the present disclosure is directed to a method. The includes receiving image data corresponding to a plurality of measured fluid properties of a subterranean region. The method also includes generating a plurality of sub-images within the image data, wherein each sub-image corresponds to a different location of the subterranean region. Further, the method includes providing each sub-image to a model, wherein the model is configured to transform each sub-image into a reduced space and generate a predicted image data based on the sub-image transformed into the reduced space. Even further, the method includes receiving the predicted image data as an output of the model. Further still, the method includes adjusting operation of a fluid system based on the predicted image data.

Another aspect of the present disclosure is directed to a non-transitory computer-readable medium comprising computer-executable instructions that, when executed, are configured to cause a processor to perform operations. The operations include receiving image data corresponding to a plurality of measured fluid properties of a subterranean region. The operations also include generating a plurality of sub-images within the image data, wherein each sub-image corresponds to a different location of the subterranean region. Further, the operations include generating a model by training the model using the plurality of sub-images, wherein training the model comprises transforming each sub-image into a reduced space and generating a predicted image data based on the sub-image transformed into the reduced space.

In another embodiment of the present disclosure, the method comprises receiving image data corresponding to a plurality of measured fluid properties of a subterranean region comprising a subterranean reservoir, the image data comprises a plurality of pixels and each pixel of the plurality of pixels corresponds to a set of the plurality of measured fluid properties; determining whether the subterranean region corresponds to an irregular geometry and modifying the irregular geometry to a regular geometry; generating a plurality of sub-images within the image data, each sub-image comprises a different portion of the image data corresponding to a different location in the subterranean region, wherein generating the plurality of sub-images within the image data comprises segmenting the image data using one or more image-segmentation techniques; interpolating the image data into processed image data corresponding to the regular geometry of the subterranean region and generating the plurality of sub-images including the processed image data; normalizing the plurality of sub-images based on a minimum value and a maximum value of the plurality of measured fluid properties; generating a model by training the model using the plurality of sub-images, wherein the model comprises a neural network and training the model comprises transforming each sub-image into a reduced space and generating a predicted image data based on the sub-image transformed into the reduced space and providing each sub-image of the plurality of sub-images to an auto-encoder architecture, wherein providing each sub-image of the plurality of sub-images to the auto-encoder architecture is done iteratively, further wherein the model comprises multiple sub-models configured to decouple a plurality of state variables associated with the image data; determining a control action based on the predicted image data; and adjusting operation of a fluid system based on the generated model, wherein the fluid system comprises one or more of a hydrogen storage system, a carbon capture and sequestration (CCS) system, a safety valve, and a fluid sampling system. This method may also include transmitting the control action, wherein the control action causes a physical wellsite action to occur; and performing the physical wellsite action in response to the control action.

In another embodiment of the present disclosure, the method comprises receiving image data corresponding to a plurality of measured fluid properties within a subterranean region comprising a subterranean reservoir; generating a plurality of sub-images within the image data, each sub-image comprises a different portion of the image data corresponding to a different location in the subterranean region; interpolating the image data into processed image data and generating the plurality of sub-images including the processed image data; normalizing the plurality of sub-images based on a minimum value and a maximum value of the plurality of measured fluid properties; generating a model by training the model using the plurality of sub-images, wherein the model comprises a neural network and training the model comprises transforming each sub-image into a reduced space and generating a predicted image data based on the sub-image transformed into the reduced space and providing each sub-image of the plurality of sub-images to an auto-encoder architecture; and adjusting operation of a fluid system based on the generated model. This method may also have the image data comprise a plurality of pixels and each pixel of the plurality of pixels corresponds to a set of the plurality of measured fluid properties. The method may further comprise determining whether the subterranean region corresponds to an irregular geometry and modifying the irregular geometry to a regular geometry. The method may also have the processed image data correspond to the regular geometry of the subterranean region. The method may also generate the plurality of sub-images within the image data by segmenting the image data using one or more image-segmentation techniques. The method may also provide each sub-image of the plurality of sub-images to the auto-encoder architecture is done iteratively, further wherein the model comprises multiple sub-models configured to decouple a plurality of state variables associated with the image data. The method may also have the fluid system comprise one or more of a hydrogen storage system, a carbon capture and sequestration (CCS) system, a safety valve, and a fluid sampling system. The method may further comprise transmitting the control action, wherein the control action causes a physical wellsite action to occur; and performing the physical wellsite action in response to the control action. The method may further comprise determining a control action based on the predicted image data.

In another embodiment of the present disclosure, the method comprises receiving image data corresponding to a plurality of measured fluid properties within a subterranean region comprising a subterranean reservoir; generating a plurality of sub-images within the image data, each sub-image comprises a different portion of the image data corresponding to a different location in the subterranean region; interpolating the image data into processed image data and generating the plurality of sub-images including the processed image data; normalizing the plurality of sub-images based on a minimum value and a maximum value of the plurality of measured fluid properties; generating a model by training the model using the plurality of sub-images, wherein the model comprises a neural network and training the model comprises transforming each sub-image into a reduced space and generating a predicted image data based on the sub-image transformed into the reduced space and providing each sub-image of the plurality of sub-images to an auto-encoder architecture, wherein providing each sub-image of the plurality of sub-images to the auto-encoder architecture is done iteratively, further wherein the model comprises multiple sub-models configured to decouple a plurality of state variables associated with the image data; and adjusting operation of a fluid system based on the generated model. In the method, the image data may comprise a plurality of pixels and each pixel of the plurality of pixels corresponds to a set of the plurality of measured fluid properties. The method may also include determining whether the subterranean region corresponds to an irregular geometry and modifying the irregular geometry to a regular geometry. The method may have the processed image data corresponding to the regular geometry of the subterranean region. The method may also generate the plurality of sub-images within the image data comprises segmenting the image data using one or more image-segmentation techniques. The method may have the fluid system comprise one or more of a hydrogen storage system, a carbon capture and sequestration (CCS) system, a safety valve, and a fluid sampling system. The method further include transmitting the control action, wherein the control action causes a physical wellsite action to occur and performing the physical wellsite action in response to the control action. The method may also comprise determining a control action based on the predicted image data.

For clarity and simplicity of description, not all combinations of elements provided in the aspects of the embodiments recited above have been set forth expressly. Notwithstanding this, the skilled person will directly and unambiguously recognize that unless it is not technically possible, or it is explicitly stated to the contrary, the consistory clauses referring to one aspect of the embodiments described herein are intended to apply mutatis mutandis as optional features of every other aspect of the embodiments to which those consistory clauses could possibly relate.

### BRIEF DESCRIPTION OF THE DRAWINGS

Various features, aspects, and advantages of this disclosure will become better understood when the following detailed description is read with reference to the accompanying figures in which like characters represent like parts throughout the figures, wherein:

FIG. 1 is a schematic diagram of a fluid system with a subterranean control system used to determine one or more fluid properties of a subsurface formation, in accordance with an embodiment of the present techniques;

FIG. 2 illustrates a block diagram of various components that may be part of the subterranean control system of FIG. 1, in accordance with an embodiment of the present techniques;

FIG. 3 is a flow diagram of an example method for controlling the fluid system of FIG. 1 based on a predictive (or proxy) model, in accordance with an embodiment of the present techniques;

FIG. 4 is a flow diagram of an example method for generating a predictive (or proxy) model using subdomain-based image training techniques, in accordance with an embodiment of the present techniques;

FIG. 5 is a schematic diagram of a first example of a training module used to generate a predictive (or proxy) model using subdomain-based image training techniques, in accordance with an embodiment of the present techniques;

FIG. 6 is a schematic diagram of a second example of a training module used to generate a predictive (or proxy) model using subdomain-based image training techniques, in accordance with an embodiment of the present techniques;

FIG. 7 is a flow diagram of an example method for generating a predicted condition or state of a subterranean region using a predictive (or proxy) model trained using subdomain-based image training techniques, in accordance with an embodiment of the present techniques;

FIG. 8 shows examples of input and output data for training a predictive (or proxy) model trained using subdomain-based image training techniques, in accordance with an embodiment of the present techniques;

FIG. 9 shows additional examples of input for training a predictive (or proxy) model trained using subdomain-based image training techniques, in accordance with an embodiment of the present techniques;

FIG. 10 shows an example of a pre-proceed input for training a predictive (or proxy) model trained using subdomain-based image training techniques, in accordance with an embodiment of the present techniques;

FIG. 11 is a flow diagram of an example method for generating a predicted condition or state of a subterranean region using a predictive (or proxy) model trained using subdomain-based image training techniques, in accordance with an embodiment of the present techniques; and

FIGS. 12A and 12B are schematic views of at least a portion of the method(s) described above, in accordance with an embodiment of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The drawing figures are not necessarily to scale. Certain features of the embodiments may be shown exaggerated in scale or in somewhat schematic form, and some details of conventional elements may not be shown in the interest of clarity and conciseness. Although one or more embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

When introducing elements of various embodiments of this disclosure, the articles “a,” “an,” and “the” are intended to mean that there are one or more of the elements. The terms “including” and “having” are used in an open-ended fashion, and thus should be interpreted to mean “including, but not limited to . . . ” Any use of any form of the terms “couple,” or any other term describing an interaction between elements is intended to mean either an indirect or a direct interaction between the elements described.

Certain terms are used throughout the description and claims to refer to particular features or components. As one skilled in the art will appreciate, different persons may refer to the same feature or component by different names. This document does not intend to distinguish between components or features that differ in name but not function, unless specifically stated.

Reference throughout this specification to “one embodiment,” “an embodiment,” “embodiments,” “some embodiments,” “certain embodiments,” or similar language means that a particular feature, structure, or characteristic described in connection with the embodiment may be included in at least one embodiment of this disclosure. Thus, these phrases or similar language throughout this specification may, but do not necessarily, all refer to the same embodiment. Although this disclosure has been described with respect to specific details, it is not intended that such details should be regarded as limitations on the scope of this disclosure, except to the extent that they are included in the accompanying claims.

Additionally, the methods and processes described below may be performed by a processor. Moreover, the term “processor” should not be construed to limit the embodiments disclosed herein to any particular device type or system. The processor may include a computer system. The computer system may also include a computer processor (e.g., a microprocessor, microcontroller, digital signal processor, or general-purpose computer) for executing any of the methods and processes described below.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described below, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described below can be implemented using such logic devices.

### Training a Reservoir Model

As mentioned above, a model for a reservoir may be used to inform certain oil and gas decisions, such as suitable locations to drill. For example, the model may be trained with image data where the number of pixels in an image is dictated by the size of the discretized computational mesh. In such examples, the number of pixels may be between 5 to 10 million cells. Thus, training the model using such large meshes could take days to weeks for one model, which may not be suitable for oil and gas operations. An oil and gas operation may benefit from modeling on a relatively shorter timescale, such as hours or days. As such, certain techniques for training models may not be suitable for certain types of data (e.g., fluid property) that may offer valuable insights for oil and gas decisions. As such, a solution is needed to provide more efficient training for fluid property model for analyzing image data associated with fluid systems.

Accordingly, the present disclosure is directed to systems and methods for a subdomain-based training of fluid property models (e.g., proxy models). A proxy model or a predictive model can be based on physics informed machine learning (PIML) and trained to predict the spatial and temporal evolution of state variables (e.g., pressure, saturations, etc.) in subsurface give different perturbations to the wells (i.e., well controls). A proxy model can also be referred to as a “digital twin” and can mimic or imitate real world models.

In general, the disclosed techniques include training a proxy model (or a predictive model) by decomposing image data of multiple measured fluid properties or conditions into subimages or subdomains of the original image data. Further, the present disclosure may include generating the proxy model that maintains use of loss functions associated with dynamic fluid properties. The measured fluid properties may include saturation, pressure, temperature, dielectric constant, and other measurable properties. Then, the techniques include training a model using the subimages. In this way, the proxy model is trained using a localized region of a computational mesh and while learning the global evolution of the state variables. To create a localized training data set, the dataset provided includes local saturation and pressure values but global well controls. In any case, the disclosed techniques capture the global effect of the well controls to local changes in condition or state. To capture the underlying shape of the state variable, the input may contain permeability and porosity channels. This information is also used to evaluate the loss functions. It should be noted that the disclosed techniques may be applied to various fluid systems, such as hydrogen storage systems, carbon capture and sequestration (CCS) systems, safety valves, fluid sampling systems, and the like.

### Wireline and Downhole Equipment

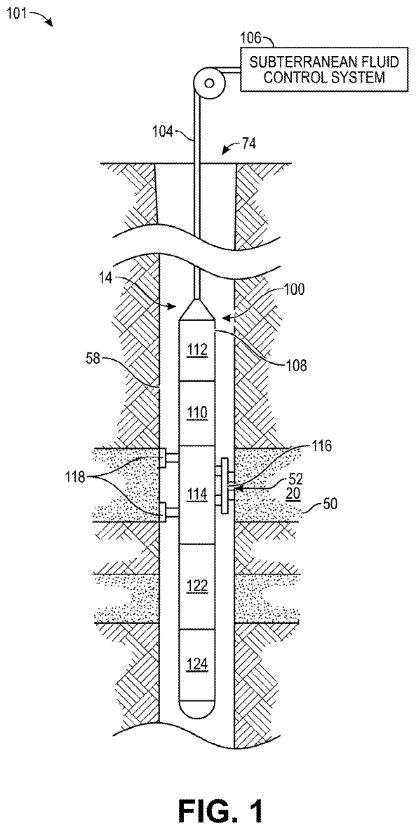

With the foregoing in mind, FIG. 1 depicts an example of a wireline downhole tool 100 of a fluid system 101 that may employ the systems and techniques described herein to determine a CO₂ concentration of the reservoir fluid 50. The wireline downhole tool 100 is suspended in the wellbore 14 from the lower end of a multi-conductor cable 104 that is spooled on a winch at the surface 74. Similar to the downhole acquisition tool 12, the wireline downhole tool 100 may be conveyed on wired drill pipe, a combination of wired drill pipe and wireline, or other suitable types of conveyance. The cable 104 is communicatively coupled to a subterranean fluid control system 106. The wireline downhole tool 100 includes an elongated body 108 that houses modules 110, 112, 114, 122, and 124 that provide various functionalities including imaging, fluid sampling, fluid testing, operational control, and communication, among others. For example, the modules 110 and 112 may provide additional functionality such as fluid analysis, resistivity measurements, operational control, communications, coring, and/or imaging, among others.

As shown in FIG. 1, the module 114 is a fluid communication module 114 that has a selectively extendable probe 116 and backup pistons 118 that are arranged on opposite sides of the elongated body 108. The extendable probe 116 is configured to selectively seal off or isolate selected portions of the wall 58 of the wellbore 14 to fluidly couple to the adjacent geological formation 20 and/or to draw fluid samples from the geological formation 20. The probe 116 may include a single inlet or multiple inlets designed for guarded or focused sampling. The reservoir fluid 50 may be expelled to the wellbore through a port in the body 108 or the formation fluid 50 may be sent to one or more modules 122 and 124. The modules 122 and 124 may include sample chambers that store the reservoir fluid 50. In the illustrated example, the subterranean fluid control system 106 and/or a downhole control system are configured to control the extendable probe assembly 116 and/or the drawing of a fluid sample from the formation 20 to enable analysis of the fluid properties of the reservoir fluid 50, as discussed above. In some embodiments, the wireline downhole tool 100 may include one or more light sources and/or light detectors disposed along a fluid conduit of the wireline downhole tool 100 to facilitate acquiring fluid property data (e.g., saturation data, pressure data, and the like) of the reservoir fluid 50.

In certain embodiments, the sensors within the downhole tool 12 may collect and transmit data associated with the characteristics of the geological formation 20 and/or the fluid properties and the composition of the reservoir fluid 50 to a subterranean fluid control system 106 at surface 74, where the data may be stored and processed in the subterranean fluid control system 106.

### Subterranean Fluid Control System

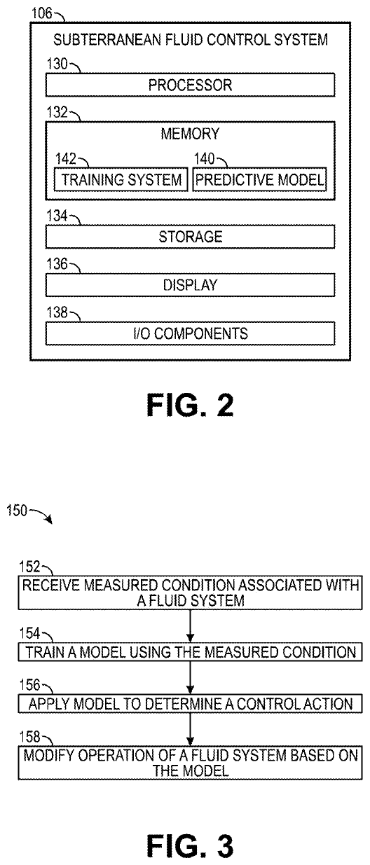

One embodiment of the subterranean fluid control system 106 is shown in FIG. 2. In general, the subterranean fluid control system 106 may be used to control operations of components or equipment associated with fluid systems such as hydrogen storage systems, CCS systems, safety valves, fluid sampling systems, and the like. As illustrated, the subterranean fluid control system 106 may include a processor 130, memory 132, storage 134, and display 136 and/or input/output (I/O) components 138. The memory 132 may include one or more tangible, non-transitory, machine readable media collectively storing one or more sets of instructions for operating the downhole tool 12, determining formation characteristics (e.g., geometry, connectivity, minimum horizontal stress, etc.) calculating and estimating fluid properties of the reservoir fluid 50, modeling the fluid behaviors using, e.g., equation of state models (EOS). The memory 132 may store reservoir modeling systems (e.g., geological process models, petroleum systems models, reservoir dynamics models, etc.), mixing rules and models associated with compositional characteristics of the reservoir fluid 50, equation of state (EOS) models for equilibrium and dynamic fluid behaviors (e.g., biodegradation, gas/condensate charge into oil, CO₂ charge into oil, fault block migration/subsidence, convective currents, among others not related to methane hydrate), and any other information that may be used to determine geological and fluid characteristics of the geological formation 20 and reservoir fluid 52, respectively. In certain embodiments, the subterranean fluid control system 106 may apply filters to remove noise from the data.

To process the data, the processor 130 may execute instructions stored in the memory 132 and/or storage 134. For example, the instructions may cause the processor to compare the data (e.g., from the logging while drilling and/or downhole analysis) with known reservoir properties estimated using the reservoir modeling systems, use the data as inputs for the reservoir modeling systems, and identify geological and reservoir fluid properties that may be used for exploration and production of the reservoir. As such, the memory 132 and/or storage 134 of the subterranean fluid control system 106 may be any suitable article of manufacture that can store the instructions. By way of example, the memory 132 and/or the storage 134 may be ROM memory, random-access memory (RAM), flash memory, an optical storage medium, or a hard disk drive. The display 136 may be any suitable electronic display that can display information (e.g., logs, tables, cross-plots, reservoir maps, etc.) relating to properties of the well/reservoir (e.g., subterranean reservoir) as measured by the downhole tool 12. It should be appreciated that, although the subterranean fluid control system 106 is shown by way of example as being located at the surface 74, the subterranean fluid control system 106 may be located in the downhole tool 12. In such embodiments, some of the data may be processed and stored downhole (e.g., within the wellbore 14), while some of the data may be sent to the surface 74 (e.g., in real time). In certain embodiments, the subterranean fluid control system 106 may use information obtained from petroleum system modeling operations, ad hoc assertions from the operator, empirical historical data (e.g., case study reservoir data) in combination with or lieu of the data to determine certain properties of the reservoir fluid 50.

As shown, the memory 132 includes a predictive model 140 (or a proxy model) and a training system 142. In general, the predictive model 140 is a proxy model (or “digital twin”) trained to determine a predicted condition based on input data corresponding a current or previous conditions. For example, the predictive model 140 may receive an input such as image data indicating multiple measured fluid properties within a subterranean formation. As such, the predictive model 140 may determine a predicted fluid property or indicating a change of the measured fluid properties at a later time t. Further, the predictive model 140 may be capable of receiving additional inputs, such as a time input corresponding to the time that the user desires to determine that properties. As such, the predictive model 140 may output a predicted measured fluid property corresponding to the time indicated by the time input.

### Model Training System

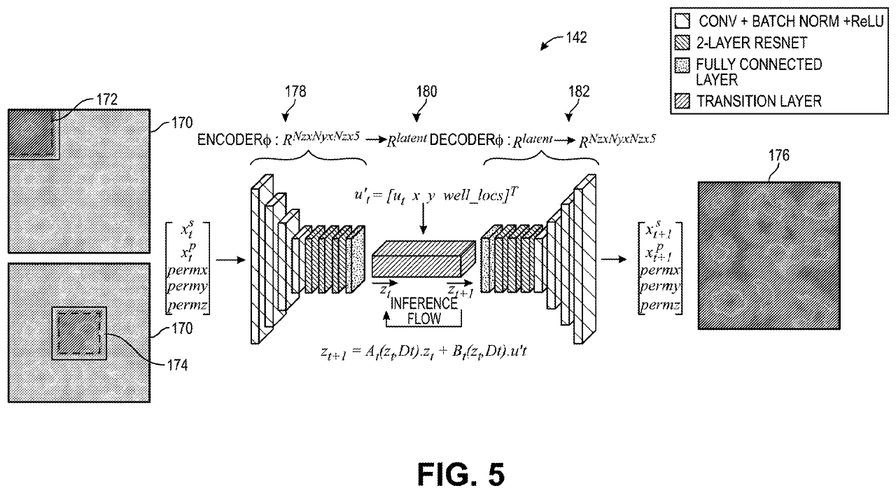

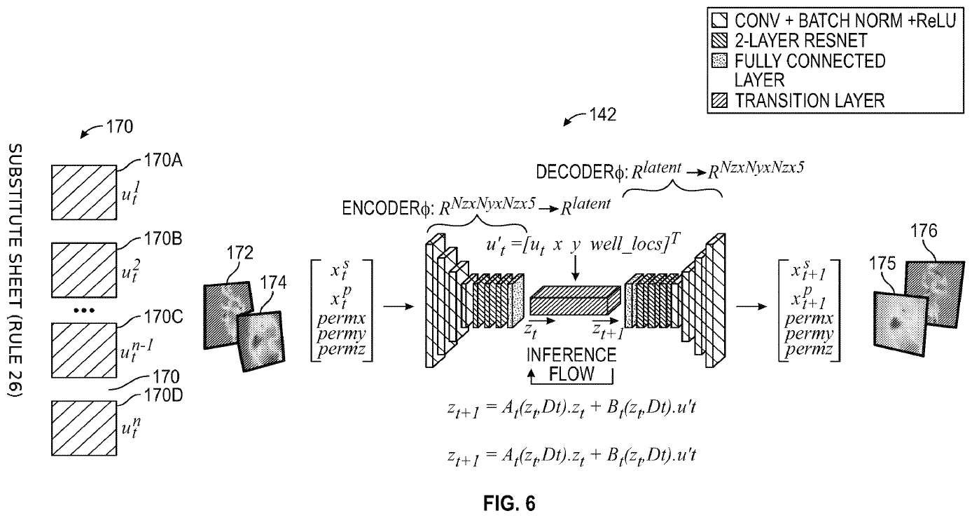

The training system 142 may generally include one or more modules that facilitate the training of the model. In general, the training system 142 may include a particular architecture, such as an auto-encoder architecture. In such an example, the training system 142 may include three modules, such as an encoder module, a neural network module, and a decoder module. The encoder module may compress the input image, thereby converting the image into a latent space dimension. Then, the converted image may be applied to a neural network module. In some embodiments, the neural network module may apply certain well controls as input. In turn, the neural network module may output a predicted state (e.g., a predicted state image) corresponding to the next temporal state of the simulation variables. The decoder module may receive the predicted state and decompress the predicted state into the original resolution. This image represents the next temporal state of pressure and saturation in the physical space. The loss functions incorporate both traditional auto-encoder losses as well as physics informed loss functions. Additional details regarding the training system 142 are described with respect to FIGS. 5 and 6.

### Method for Utilizing a Predictive Model

As described herein, the subterranean fluid control system 106 may perform subdomain-based training techniques to generate or train the predictive model 140 used to inform oil and gas operations. FIG. 3 is a flow chart of a method 150 for utilizing the predictive model 140 to modify or adjust operation of a fluid system based on the model. In some embodiments, the method may be implemented by executing instructions stored in a tangible, non-transitory, computer-readable medium, such as the memory 132, using the processor 130. While the method 150 is described using steps in a specific sequence, it should be understood that the present disclosure contemplates that the described steps may be performed in different sequences than the sequence illustrated, and certain described steps may be skipped or not performed altogether.

At block 152, the processor 130 receives a measured condition associated with a fluid system. In general, the measured condition may be data corresponding a particular condition during a time period. For example, the measured condition may be an image with pixels representing one or more measured fluid properties during the time period. For example, a single pixel can have a pixel value indicative of multiple properties. In some embodiments, the measured fluid property may include a pressure, a temperature, a saturation, a viscosity, a water content, a fluid composition, a dielectric constant, or other fluid properties of region of the reservoir fluid 50.

At block 154, the processor 130 trains a model using the measured condition. In general, training the model includes generating multiple sub-images based on an original image. As described herein, the original image may include pixels that provide information regarding a subterranean region. For example, each pixel may represent a location within the subterranean region and each pixel may include a value that indicates one or more conditions corresponding to the location. To do so, the processor 130 may identify multiple subdomains of the images. Each subdomain corresponds to a different portion (e.g., different location, different depth, and/or different area) of the subterranean area corresponding to the image. After identifying the subdomains, the processor 130 provides a first subdomain to the training system 142. In turn, the training system 142 trains the predictive model 140 to output a first predicted condition based on the first domain. Then, the training system 142 proceeds to iterate through each of the subdomains, thereby training the model on each of the subdomains or sub-images. In some embodiments, the processor 130 may receive input indicating preferences for the sub-images, such as a size of each sub-image, a maximum size of each sub-image, a minimum size of each sub-image, overlap between sub-images, a threshold distance between sub-images, and the like.

At block 156, the processor 130 applies the model to determine a control action using the model. That is, the model may receive a measured condition and output a predicted condition based on the measured condition. In turn, the model may determine a particular control action corresponding to the predicted condition. In general, the control action may include an audible and/or visual alert (e.g., a notification displayed on a computing device, such as a laptop, mobile device, tablet, or otherwise) or cause a component of the fluid system to modify operation. For example, the control action may be a control signal or activation signal that causes a device of the fluid system to stop operating or change operation or position. As another non-limiting example, the control signal may cause a drill to stop drilling, a valve to open or close, and/or a fluid flow rate to change. In some embodiments, the control action may be an indication or alert displayed on a computing device, indicating an amount or present of fluids in a particular region. For example, the indication or alert may include location information (e.g., a depth within the subterranean region).

At block 158, the processor 130 modifies or adjusts operation of a fluid system using the model. In general, the processor 130 modifying or adjusting operation of the fluid system includes outputting a control signal that causes the control action to occur. For example, if the processor 130 determines, based on the predictive model 140 that a fluid is accumulating in a particular region, the control action may be a control signal that causes or indicates to an operator that the fluid from the particular region should be extracted. In this way, a model may inform oil and gas operations to improve the efficiency of extracting resources and/or identifying areas where not to drill.

### Method for Training a Predictive Model

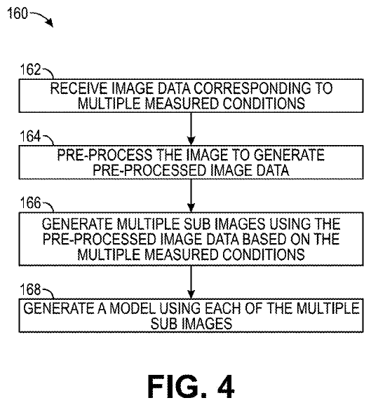

As described herein, the subterranean fluid control system 106 may perform subdomain based training techniques to generate or train the predictive model 140 used to inform oil and gas operations. FIG. 4 is a flow chart of a method 160 for training the predictive model 140 to modify or adjust operation of a fluid system based on the model. In some embodiments, the method may be implemented by executing instructions stored in a tangible, non-transitory, computer-readable medium, such as the memory 132, using the processor 130. While the method 160 is described using steps in a specific sequence, it should be understood that the present disclosure contemplates that the described steps may be performed in different sequences than the sequence illustrated, and certain described steps may be skipped or not performed altogether.

At block 162, the processor 130 receives an image (e.g., image data) corresponding to multiple measured fluid properties of a subterranean formation. In some embodiments, the measured fluid property may include a pressure, a temperature, a saturation, a viscosity, a water content, a fluid composition, a dielectric constant, or other fluid properties of region of the reservoir fluid 50 . . . . In general, the image data may include pixels indicating a position, location, or area within the subterranean formation, and the one or more measured fluid properties. For example, the image data may correspond to a layer within a subterranean formation. Further, each pixel may have a value (e.g., indicated by a color or shading) corresponding to a particular measured fluid property or a composite fluid property (e.g., a single value corresponding to multiple fluid properties).

At block 164, the processor 130 pre-processes the image to generate pre-processed image data. In some embodiments, pre-processing the image may include denoising, filtering, compressing, decompressing, or other techniques such that the image is suitable (e.g., having a suitable signal or size) for training.

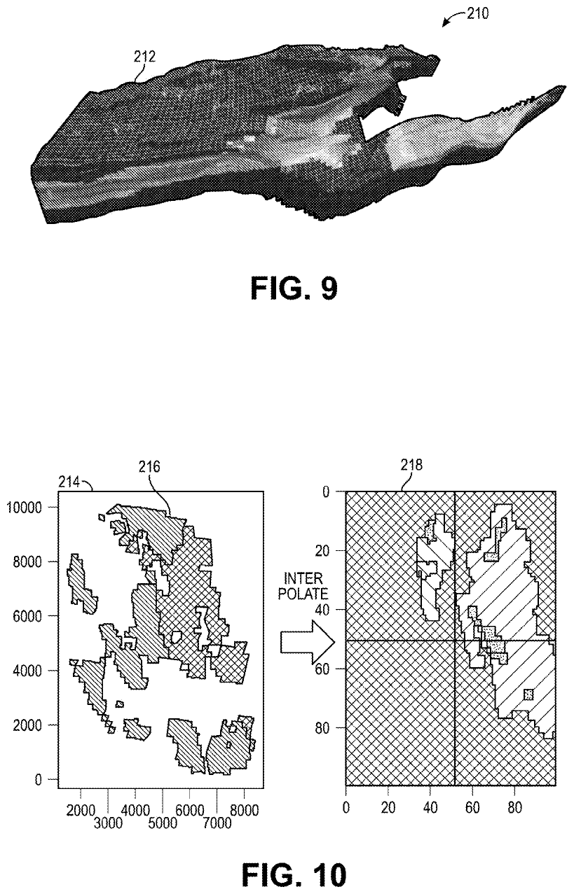

In some embodiments, the processor 130 may perform block 164 after determining that the geometry of an image corresponds to an irregular geometry. The irregular geometry of the image is described in more detail with respect to FIG. 9. As an example process for pre-processing an irregular image, the processor 130 may first determine that the image corresponds to an irregular geometry. To do so, for example, the processor 130 may determine a shape or geometry of a perimeter of the image and determine whether the shape corresponds to a regular or irregular shape or geometry. For example, the processor may determine the number of sides of the shape of the image, one or more angles between the sides, and the like. If the processor 130 determines that the shape corresponds to an irregular shape, the processor 130 may interpolate the image onto a regular domain that forms a bounding box or perimeter to the irregular shape. The bounding box is generally illustrated in FIG. 10.

At block 166, the processor 130 generates multiple sub-images using the pre-processed image data based on the multiple measured conditions. In general, the processor 130 may employ various segmenting or subdomain techniques. For example, the processor 130 may employ threshold segmentation, edge-based segmentation, clustering-based segmentation, and other image-segmentation techniques.

At block 168, the processor 130 generates the predictive model 140 using each of the multiple images. In general, the processor generates the predictive model by iteratively training the model using each of the sub-images. In some embodiments, the processor 130 may train the model by providing each of the sub-images to an auto-encoder architecture including a decoder module, a transition module, and an encoder module, as described in more detail below with respect to FIG. 5.

### Example of a Training System

FIG. 5 shows a first example of the training system 142 in accordance with certain embodiments. In general, the training system 142 receives multiple images 170 corresponding to different subdomains of an original image. For example, the first image 170 (top) corresponds to a first subdomain image 172 (e.g., a first sub-image). The second image 170 (bottom) corresponds to a second subdomain image 174 (e.g., a second sub-image). The training system 142 trains a predictive model 140, as described in FIG. 2, using the first subdomain image 172 and the second subdomain image 144 to generate a predicted image 176 (e.g., a predicted image indicating a predicted condition) that corresponds to a predicted state of the original image 170. It should be noted that, while only two subdomain images 172 and 174 are shown, the training system 142 may receive more subdomain images of an original image 170, such as at least 5, 10, 15, 20, 30, 40, 50, 100, or more subdomain images.

The illustrated embodiment of the training system 142 includes three modules (e.g., software modules): an encoder module 178, a transition module 180, and a decoder module 182. The encoder module 178 generates a reduced space or state of the received sub-image. For example, the encoder module 178 may transform a first set of properties of the system-state variables at a high-dimension, x, to a second set of properties of the system-state variables at a low dimension, z. In some embodiments, the processor 130 may normalize each of the properties of the first set of properties. For example, in an embodiment in which the image data includes saturation and pressure data, the processor 130 may normalize the saturation data inputs and the pressure data inputs. As one non-limiting example, the processor 130 may utilize a min-mix normalization method (e.g., using a first minimum value corresponding to a first fluid property and a first maximum value corresponding to the first fluid property, a second minimum value corresponding to a second fluid property and a second maximum value corresponding to the second fluid property, and so on), such as:

$${\overline{p}}_{k} = \frac{{\overline{p}}_{k} - {p}_{min}}{{p}_{max} - {p}_{min}} \qquad ( 1 )$$

Where k=1, 2, . . . , N; the bar symbol denotes the normalization of the variable, p, the pressure. The minimum and maximum values for each variable may be same for all time steps.

The transition module 180 generally includes a function that maps the reduced state to the latent state associated with the predictive model 140. As shown in the illustrated embodiment, the transition module 180 may use the function:

$${z}_{t + 1} = {A}_{t} ( {z}_{t} , Δ t ) \cdot {z}_{t} + {B}_{t} ( {z}_{t} , Δ t ) \cdot {u}_{t}^{′} \qquad ( 2 )$$

Where uₜ′ is a vector of certain perturbations into the fluid system; zₜ₊₁ is the predicted condition in the reduced state; and Aₜ and Bₜ are the system Jacobian matrix. In some embodiments, the transition module 180 may include a neural network. In some embodiments, the transition module 180 may include multiple, separate sub-models (e.g., neural networks). It is presently recognized that using separate multiple sub-models that may decouple the various state variables to address the multi-physics and multiscale nature of the fluid system.

The decoder module 182 generates a predicted condition or state based on the predicted condition in the reduced state. Put differently, the decoder module 182 transforms the predicted condition from the latent state to an image, xₜ₊₁.

### Sub-Image Training of Model

As described herein, the predictive model 140, as described in FIG. 2, may be trained using multiple sub-images of an original image corresponding to a particular time period. As such, each sub-image of the original image corresponds to the same time period. As an illustration, FIG. 6 shows a second example of the training system 142. The training system 142 receives multiple images 170a, 170b, 170c, and 170d (i.e., collectively, images 170) as input u. Each of the images 170 corresponds to the measured fluid properties at a different time. For example, the image 170a may be image data having pixels indicating a first fluid property (e.g., saturation) and a second fluid property (e.g., pressure) at a first time period. The image 170b may be image data having pixels indicating a first fluid property (e.g., saturation) and a second fluid property (e.g., pressure) at a second time period, different than the first time period. The image 170c may be image data having pixels indicating a first fluid property (e.g., saturation) and a second fluid property (e.g., pressure) at a third time period, different than the first time period and the second time period. The image 170d may be image data having pixels indicating a first fluid property (e.g., saturation) and a second fluid property (e.g., pressure) at a third time period, different than the first time period, the second time period, and the third time period. Accordingly, the sub-images generated by the processor 130 for each of the images 170 are provided to the training system 142, thereby generating predicted outputs 175 and 176.

### Method for Generating a Predicted Condition

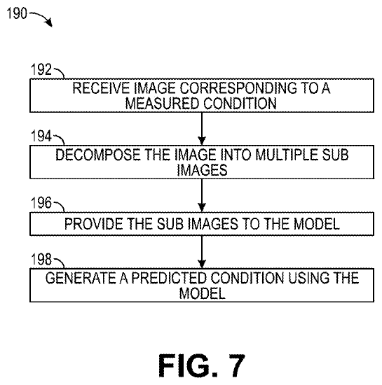

As described herein, the subterranean fluid control system 106 may perform subdomain based training techniques to generate or train the predictive model 140 used to inform oil and gas operations. FIG. 7 is a flow chart of a method 190 for generating a predicted condition using the predictive model 140 as described in FIG. 2. In some embodiments, the method may be implemented by executing instructions stored in a tangible, non-transitory, computer-readable medium, such as the memory 132, using the processor 130. While the method 190 is described using steps in a specific sequence, it should be understood that the present disclosure contemplates that the described steps may be performed in different sequences than the sequence illustrated, and certain described steps may be skipped or not performed altogether.

At block 192, the processor 130 receives an image corresponding to a measured condition. The processor 130 may perform block 192 in a generally similar manner as described with respect to block 152 of the process 150. At block 194, the processor 130 decomposes the image into multiple sub-images. The processor 130 may perform block 194 in a generally similar manner as described with respect to block 166. In some embodiments, the processor 130 may perform the techniques associated with block 164, such as in embodiments in which the image data corresponds to an irregular shape. At block 196, the processor 130 provides each of the sub-images to the predictive model. The processor 130 may perform block 196 in a generally similar manner as described with respect to block 168. At block 198, the processor 130 generates a predicted condition using the predictive model. For example, the processor 130 may receive an image corresponding to the predicted condition. In some embodiments, the processor 130 may determine a control action to perform based on the predicted condition. For example, the processor 130 may access a reference data, table, or otherwise, that stores control actions to perform when the predicted condition is within a certain threshold range. More specifically, if the predicted condition indicates fluid is rapidly flowing into a particular region at a rate about a threshold rate, the processor 130 may send a control signal that adjusts a position of one or more valves.

### Examples of Predicted Conditions

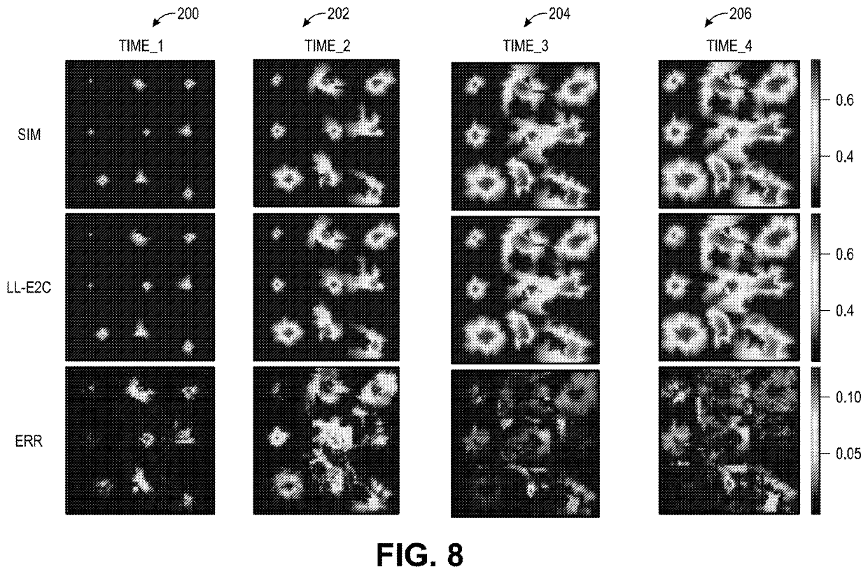

As described herein, an output of the predictive model 140 may be a predicted condition or state of a subterranean formation. As an illustration, FIG. 8 shows examples of predicted conditions 202, 204, 206, and 208 for training a predictive model trained using subdomain-based image training techniques. In the illustrated embodiment, the predicted conditions 202, 204, 206, and 208 are pressure and saturation fields for a first layer of a multi-layer (e.g., 2 layers, 2 layers, 3 layers, 4 layers, or more than 4 layers) reservoir model. Each of the predicted conditions 202, 204, 206, and 208 correspond to a different time period. Put differently, the predicted conditions 202, 204, 206, and 208 (from left to right) illustrate a change of the pressure and saturation after a time interval. As illustrated, the predicted conditions 202, 204, 206, and 208 generally show pressure and saturation that are increasing and expanding. In some embodiments, the time interval may be provided as input to the predictive model 140 described in FIG. 2. As such, the predictive model may output a predicted condition (e.g., predicted state, well output, etc.) of a region of a subterranean formation after the time interval. Additionally, the predictive model may output a prediction indicating a derived property matches a simulation result.

The first row corresponds to a first type of model, and the second row corresponds to a second type of model. In certain embodiments, the first type model differs from the second type of model in the training process. More specifically, the second row corresponds to a predictive model trained in accordance with the disclosed techniques. The third row shows an absolute difference between the outputs of the first model and the outputs of the second model. In certain embodiments, the second model is trained using the subdomain-based training techniques disclosed herein.

### Examples of Input and Output Data

FIG. 9 shows additional examples of input and output data for training a predictive model trained using subdomain-based image training techniques, in accordance with an embodiment of the present techniques. In particular, FIG. 9 shows an irregular shaped image 210 corresponding to subterranean formation. That is, the perimeter 212 of the image 210 does not include angles and/or sides that measure the same or the number of sides exceeds a threshold (e.g., 3 sides, 4 sides, 5 sides). Accordingly, the processor 130 may determine to interpolate the irregular shaped image 210 into a regular boundary perimeter.

### Example of a Boundary Perimeter

FIG. 10 illustrates a boundary perimeter 214 being applied to a layer or cross section 216 that corresponds to the irregular shaped image 210. Then, the processor 130 may interpolate each layer onto the cross section 216. The processor 130 may proceed to do this for each fluid property. Once each fluid property (e.g., the pixel value corresponding to the fluid property) is interpolated into the boundary perimeter, the processor 130 may segment the interpolated image 218. Segmentation lines 220 are shown to illustrate an example of how the interpolated image 218 may be segmented. Then, the processor 130 may utilize each of the image segments formed based on the segmentation lines 220 to train the predictive model 140 and/or determine a predicted condition.

### Method for Generating a Control Action

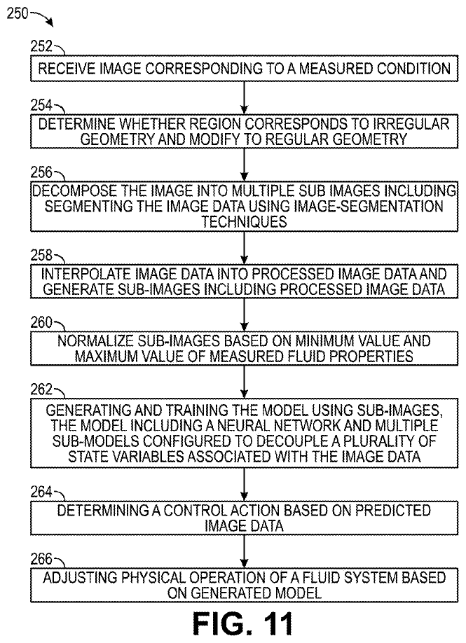

An alternative embodiment is shown at FIG. 11, which is a flow chart of a method 250 for generating a control action using a model. In some embodiments, the method may be implemented by executing instructions stored in a tangible, non-transitory, computer-readable medium, such as the memory 132, using the processor 130. While the method 190 is described using steps in a specific sequence, it should be understood that the present disclosure contemplates that the described steps may be performed in different sequences than the sequence illustrated, and certain described steps may be skipped or not performed altogether.

At block 252, the processor 130 receives an image corresponding to a measured condition. The processor 130 may perform block 252 in a generally similar manner as described with respect to block 152 of the process 150.

At block 254, the processor 130 determines whether the image region corresponds to an irregular geometry and, if necessary, modifies the image region to a regular geometry.

At block 256, the processor 130 decomposes the image into multiple sub-images. The processor 130 may perform block 256 in a generally similar manner as described with respect to block 166. In some embodiments, the processor 130 may segment the image data using image-segmentation techniques.

At block 258, the processor 130 interpolates image data into processed image data and generates sub-images including processed image data.

At block 260, the processor 130 normalizes sub-images based on a minimum and maximum value of measured fluid properties.

At block 262, the processor generates the model and trains the model using sub-images. The model may include a neural network and may be divided into multiple sub-models configured to decouple a plurality of state variables associated with the image data.

At block 264, the processor may determine a control action based on predicted image data, e.g., by utilizing the model generated and trained at block 262. For example, the processor 130 may access a reference data, table, or otherwise, that stores control actions to perform when the predicted condition is within a certain threshold range. By way of more specific example, if the model indicates fluid is rapidly flowing into a particular region at a rate about a threshold rate, the processor 130 may send a control action that adjusts a position of one or more valves. Block 266 presents adjusting some physical operation of a system, e.g., a surface of subterranean fluid control system, based on the model generated and trained at block 262.

Accordingly, the present disclosure relates to a subdomain based training technique. In general, the techniques include decomposing or breaking down an image into local blocks that are then used in a training system (e.g., including a neural network). Technical effects of this disclosure include reducing the training time for generating a predictive model significantly. As such, the predictive models may better inform oil and gas decisions. It should be noted that although the above-disclosure generally described techniques applied to two-dimensional images, the disclosed techniques may also be applied to three-dimensional image data.

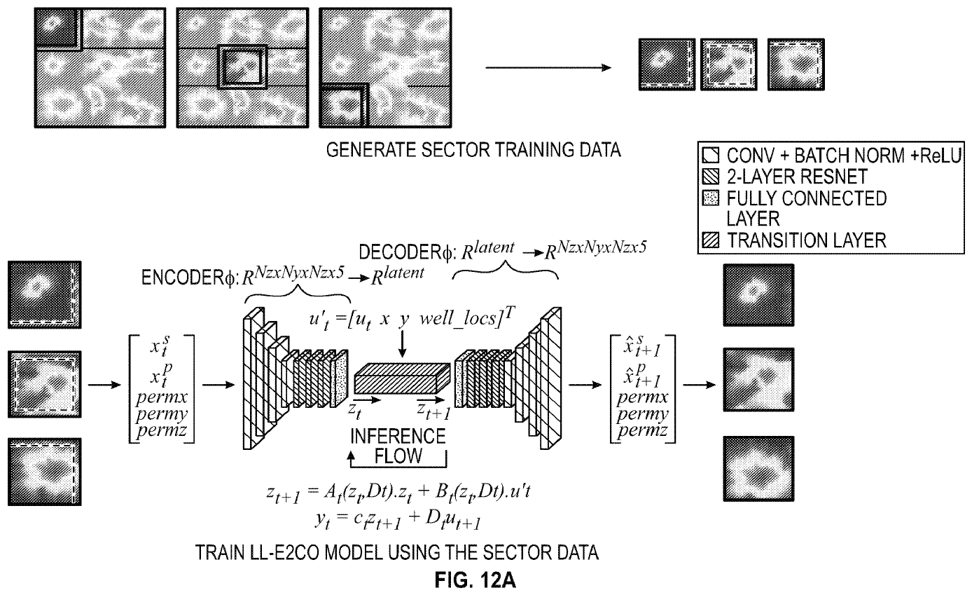

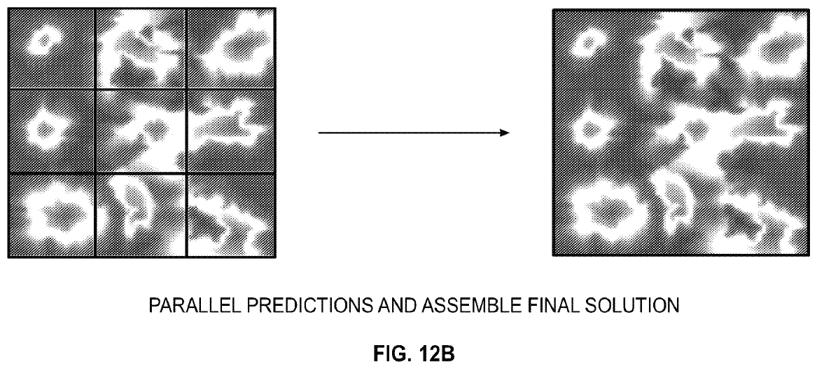

FIGS. 12A and 12B are schematic views of at least a portion of the method(s) described above, in accordance with an embodiment of the present techniques. As shown, sector training data may be generated. Then, the (e.g., localized learning E2CO) model may be trained using the sector data. Then, a plurality of predictions may be made (e.g., in parallel) using the trained model, and a final solution may be determined based upon one or more of the predictions.

While the embodiments set forth in this disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. A method of training fluid system predictive models, comprising:
receiving image data corresponding to a plurality of measured fluid properties within a subterranean region comprising a subterranean reservoir;
generating a plurality of sub-images within the image data, each sub-image comprises a different portion of the image data corresponding to a different location in the subterranean region;
interpolating the image data into processed image data and generating the plurality of sub-images including the processed image data;
normalizing the plurality of sub-images based on a minimum value and a maximum value of the plurality of measured fluid properties; and
generating a model by training the model using the plurality of sub-images, wherein the model comprises a neural network, and wherein training the model comprises:
transforming each sub-image into a reduced space;
generating a predicted image data based on the sub-image transformed into the reduced space; and
providing each sub-image of the plurality of sub-images to an auto-encoder architecture.

2. The method of claim 1, wherein the image data comprises a plurality of pixels and each pixel of the plurality of pixels corresponds to a set of the plurality of measured fluid properties.

3. The method of claim 1, further comprising:
determining whether the subterranean region corresponds to an irregular geometry; and
modifying the irregular geometry to a regular geometry.

4. The method of claim 3, wherein the processed image data corresponds to the regular geometry of the subterranean region.

5. The method of claim 1, wherein generating the plurality of sub-images within the image data comprises segmenting the image data using one or more image-segmentation techniques.

6. The method of claim 1, wherein providing each sub-image of the plurality of sub-images to the auto-encoder architecture is done iteratively, further wherein the model comprises multiple sub-models configured to decouple a plurality of state variables associated with the image data.

7. The method of claim 1, further comprising generating a signal in response to the trained model.

8. The method of claim 7, wherein the signal causes an operation of a fluid system to be adjusted.

9. The method of claim 8, wherein the fluid system comprises one or more of a hydrogen storage system, a carbon capture and sequestration (CCS) system, a safety valve, and a fluid sampling system.

10. A computing system, comprising:
one or more processors; and
a memory system comprising one or more non-transitory computer-readable media storing instructions that, when executed by at least one of the one or more processors, cause the computing system to perform operations, the operations comprising:
receiving image data corresponding to a plurality of measured fluid properties within a subterranean region comprising a subterranean reservoir;
generating a plurality of sub-images within the image data, each sub-image comprises a different portion of the image data corresponding to a different location in the subterranean region;
interpolating the image data into processed image data and generating the plurality of sub-images including the processed image data,
normalizing the plurality of sub-images based on a minimum value and a maximum value of the plurality of measured fluid properties; and
generating a model by training the model using the plurality of sub-images, wherein the model comprises a neural network, wherein training the model comprises:
transforming each sub-image into a reduced space;
generating a predicted image data based on the sub-image transformed into the reduced space; and
providing each sub-image of the plurality of sub-images to an auto-encoder architecture, wherein providing each sub-image of the plurality of sub-images to the auto-encoder architecture is done iteratively, and wherein the model comprises multiple sub-models configured to decouple a plurality of state variables associated with the image data.

11. The computing system of claim 10, wherein the image data comprises a plurality of pixels and each pixel of the plurality of pixels corresponds to a set of the plurality of measured fluid properties.

12. The computing system of claim 10, further comprising:
determining whether the subterranean region corresponds to an irregular geometry; and
modifying the irregular geometry to a regular geometry.

13. The computing system of claim 12, wherein the processed image data corresponds to the regular geometry of the subterranean region.

14. The computing system of claim 10, wherein generating the plurality of sub-images within the image data comprises segmenting the image data using one or more image-segmentation techniques.

15. The computing system of claim 10, further comprising generating a signal in response to the sub-image and the predicted image data.

16. The computing system of claim 15, wherein the signal causes an operation of a fluid system to be adjusted.

17. The computing system of claim 16, wherein the fluid system comprises one or more of a hydrogen storage system, a carbon capture and sequestration (CCS) system, a safety valve, and a fluid sampling system.

18. A non-transitory computer-readable medium storing instructions that, when executed by one or more processors of a computing system, cause the computing system to perform operations, the operations comprising:
receiving image data corresponding to a plurality of measured fluid properties of a subterranean region comprising a subterranean reservoir, the image data comprises a plurality of pixels and each pixel of the plurality of pixels corresponds to a set of the plurality of measured fluid properties;
determining whether the subterranean region corresponds to an irregular geometry and modifying the irregular geometry to a regular geometry;
generating a plurality of sub-images within the image data, each sub-image comprises a different portion of the image data corresponding to a different location in the subterranean region, wherein generating the plurality of sub-images within the image data comprises segmenting the image data using one or more image-segmentation techniques;
interpolating the image data into processed image data corresponding to the regular geometry of the subterranean region and generating the plurality of sub-images including the processed image data;
normalizing the plurality of sub-images based on a minimum value and a maximum value of the plurality of measured fluid properties;
generating a model by training the model using the plurality of sub-images, wherein the model comprises a neural network, wherein training the model comprises:
transforming each sub-image into a reduced space;
generating a predicted image data based on the sub-image transformed into the reduced space; and
providing each sub-image of the plurality of sub-images to an auto-encoder architecture, wherein providing each sub-image of the plurality of sub-images to the auto-encoder architecture is done iteratively, and wherein the model comprises multiple sub-models configured to decouple a plurality of state variables associated with the image data; and
generating and transmitting a signal in response to the sub-image and the predicted image data.

19. The non-transitory computer-readable medium of claim 18, wherein the signal causes an operation of a fluid system to be adjusted.

20. The non-transitory computer-readable medium of claim 19, wherein the fluid system comprises one or more of a hydrogen storage system, a carbon capture and sequestration (CCS) system, a safety valve, and a fluid sampling system.
